(19) United States
(12) Patent Application Publication
(10) Pub. No.: US 2019/0037992 A1
(43) Pub. Date: Feb. 7, 2019

(54) Writing Instrument Organizer

(71) Applicant: Michael Kirk Thompson, Edmond, OK (US)

(72) Inventor: Michael Kirk Thompson, Edmond, OK (US)

(21) Appl. No.: 15/668,050

(22) Filed: Aug. 3, 2017

(51) Int. Cl. A45C 11/34; A45C 11/36; B43K 23/00; B43M 99/00

(52) U.S. Cl. CPC A45C 11/34; A45C 11/36; A45C 11/00; B43M 99/006; B43K 23/001

(57) ABSTRACT

A writing instrument organizer (10) which holds at least one writing instrument such as a pen or marker (42) and retains the lid (40) within the organizer (12) when the marker (42) is withdrawn. At least one hole (18) is located in a front plate (12) which is held parallel at a distance from a back plate (14) by end caps (16). The lid retention hole (18) in the front plate (12) is sized so that a standard marker or pen lid (42) cannot slip through when a marker (40) is pulled away from the organizer (10). The end plates (16) connect the back plate (14) to the front plate (12) and ensure the marker lid (42) is properly seated in the lid retention hole (18) in front plate (12).

### CROSS REFERENCE TO RELATED APPLICATIONS/INCORPORATION BY REFERENCE STATEMENT

This application claims benefit to provisional application US 62/371,861 filed Aug. 8, 2016

### STATEMENT REGARDING FEDERALLY SPONSORED RESEARCH OR DEVELOPMENT

Not applicable.

### BACKGROUND

Commercially available marker and pen organizers have been around a long time. They are typically wall mounted near a whiteboard or placed upon a desk. These units allow the writing instruments to be removed from the organizer and then replaced. The problem with the current methods is that they do nothing to retain the lids of the markers or pens. The user is left to keep track of the lids, which can frequently wander off or forget to be replaced upon the markers or pens. This invention allows a user to place their markers or pens in the organizer and it retains the lids in a semi permanent fashion so that the lids do not get misplaced.

### Drawing Labels

| | | |
|---|---|---|
| Organizer Assembly - | Lid Retention Hole - | Mounting Wedge - 30 |
| 10 | 18 | |
| Front Plate - 12 | Lid Alignment Hole - | U Retention Slot - 32 |
| | 20 | |
| Rear Plate - 14 | Plate Locking Tab - | Writing Instrument - |
| | 22 | 40 |
| End Plate - 16 | End Cap Slot - 24 | Instrument Lid -4 |

### BRIEF DESCRIPTION OF THE DRAWINGS

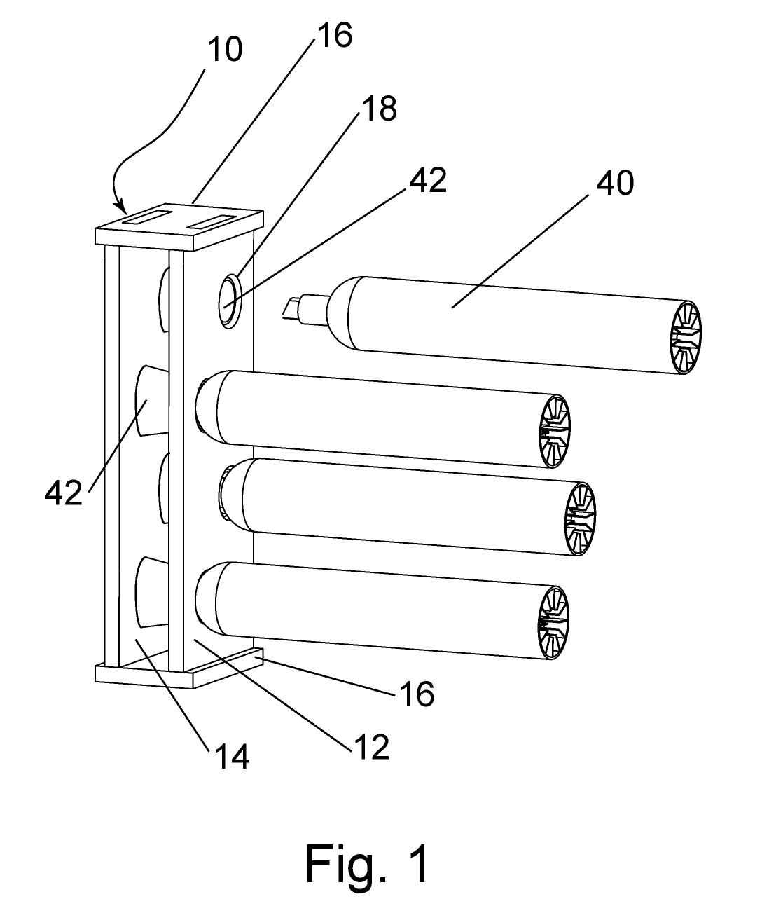

FIG. 1 shows a perspective view of a possible marker organizer configuration with markers

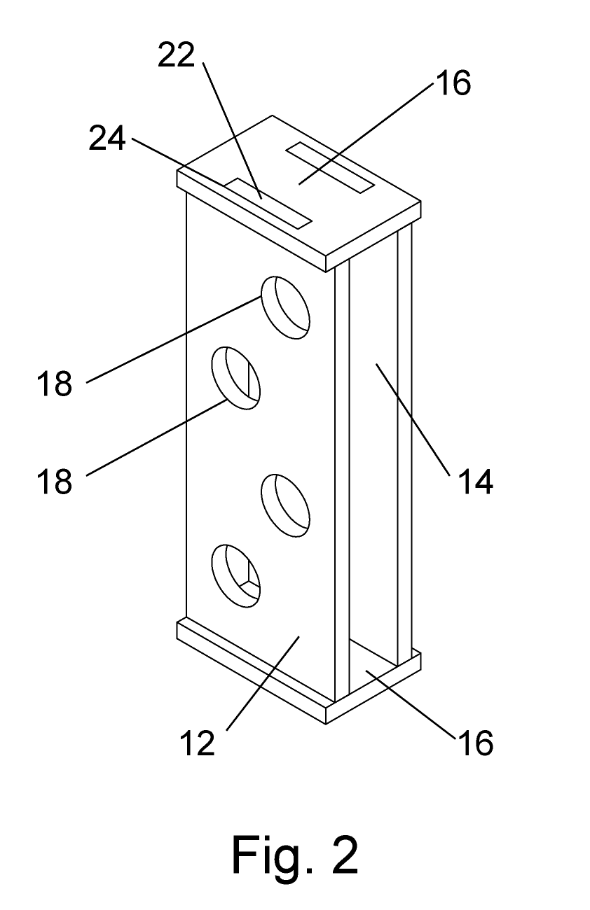

FIG. 2 shows a perspective view of an empty marker organizer

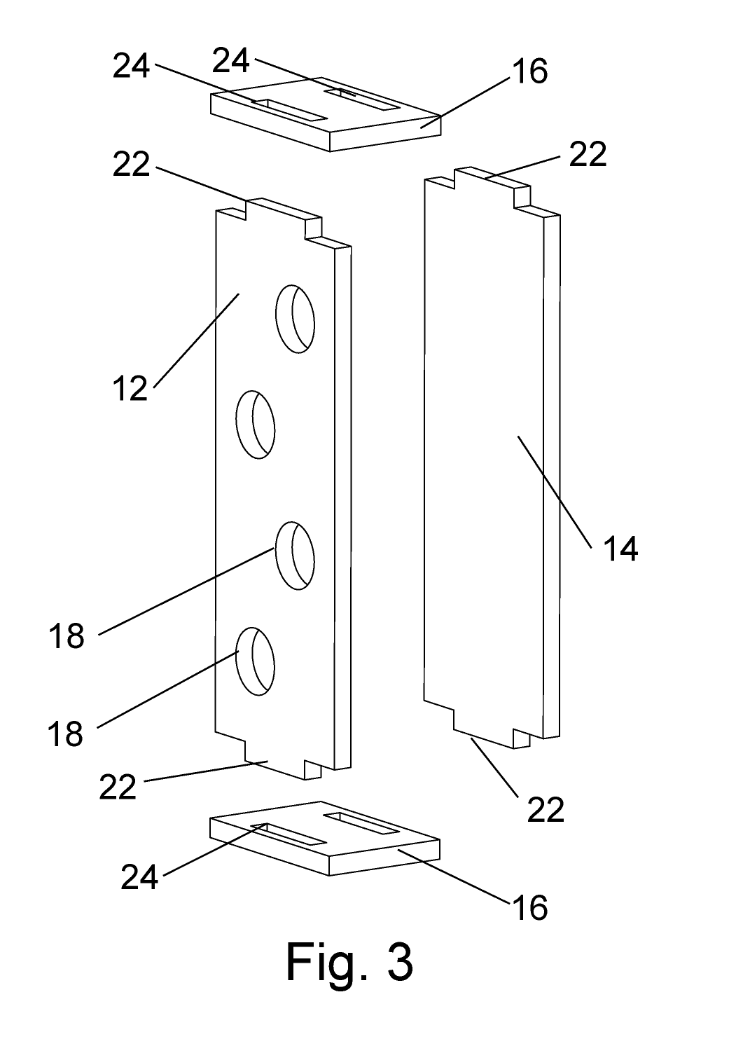

FIG. 3 is a perspective view of the different components that make up a marker organizer

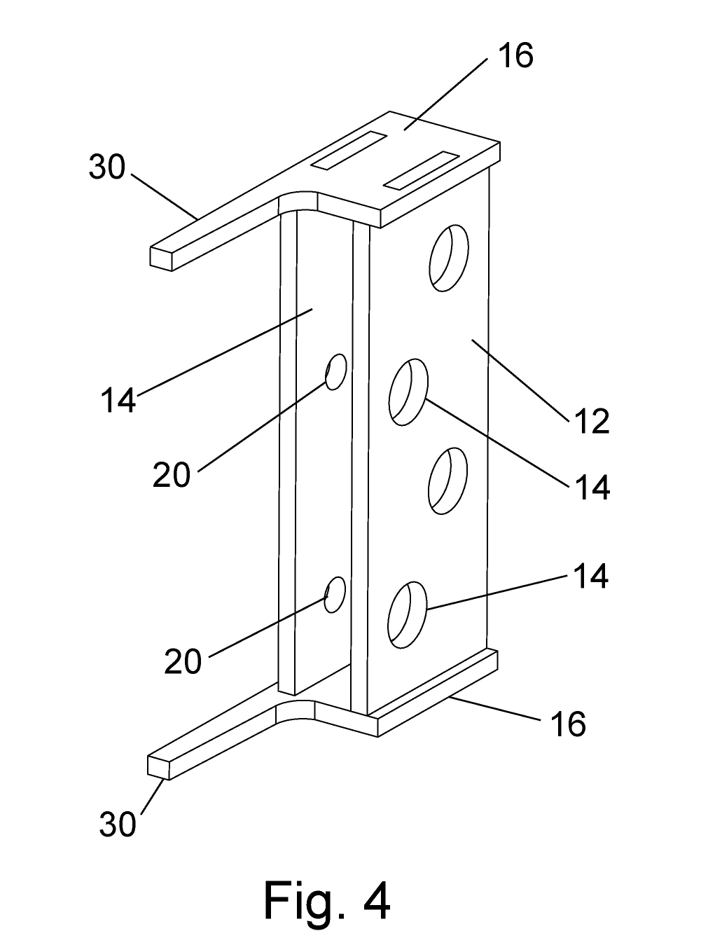

FIG. 4 shows an alternative embodiment with mounting wedges and marker alignment holes

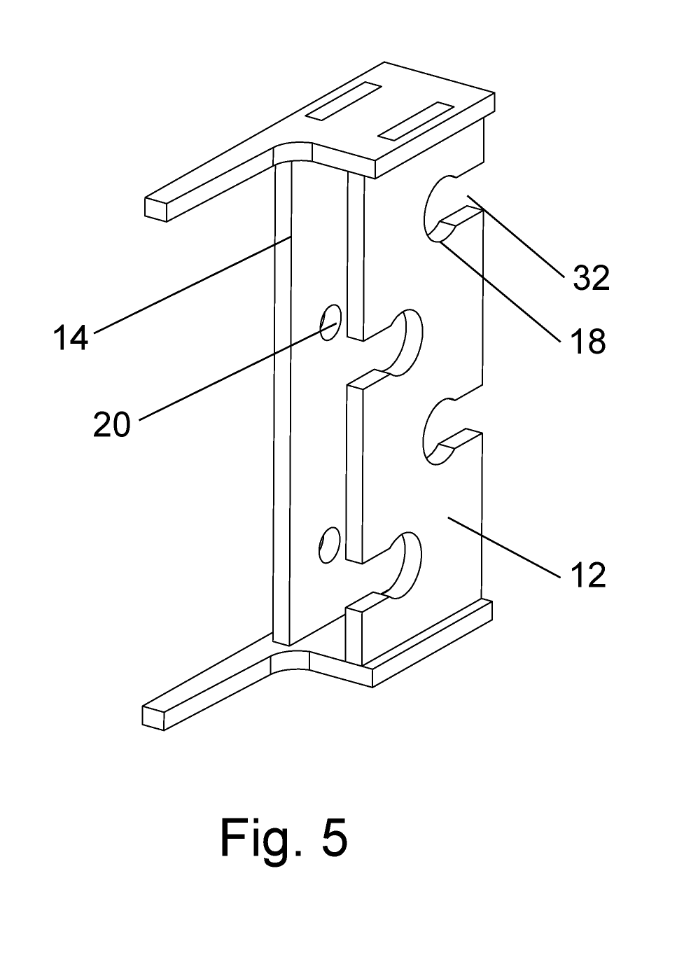

FIG. 5 is an alternative embodiment showing slotted lid retention holes

### DETAILED DESCRIPTION OF THE PREFERRED EMBODIMENTS

Several embodiments of the presently disclosed inventive concepts are hereby illustrated in the appended drawings. It is to be noted however, that the appended drawings only illustrate several typical embodiments and are therefore not intended to be considered limiting of the scope of the presently disclosed inventive concepts. Further, in the appended drawings, like or identical reference numerals or letters may be used to identify common or similar elements and not all such elements may be so numbered. The figures are not necessarily to scale and certain features and certain views of the figures may be shown as exaggerated in scale or in schematic in the interest of clarity and conciseness. Any dimensions shown in the figures are not limited to those shown therein and are only intended to be exemplary.

Before describing various embodiments of the presently disclosed inventive concepts in more detail by way of exemplary description, examples, and results, it is to be understood that the presently disclosed inventive concepts are not limited in application to the details of methods and compositions as set forth in the following description. The presently disclosed inventive concepts are capable of other embodiments or of being practiced or carried out in various ways. As such, the language used herein is intended to be given the broadest possible scope and meaning; and the embodiments are meant to be exemplary, not exhaustive. Also, it is to be understood that the phraseology and terminology employed herein is for the purpose of description and should not be regarded as limiting unless otherwise indicated as so. Moreover, in the following detailed description, numerous specific details are set forth in order to provide a more thorough understanding of the disclosure. However, it will be apparent to a person having ordinary skill in the art that the presently disclosed inventive concepts may be practiced without these specific details. In other instances, features which are well known to persons of ordinary skill in the art have not been described in detail to avoid unnecessary complication of the description.

Unless otherwise defined herein, scientific and technical terms used in connection with the presently disclosed inventive concepts shall have the meanings that are commonly understood by those having ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which the presently disclosed inventive concepts pertain. All patents, published patent applications, and non-patent publications referenced in any portion of this application are herein expressly incorporated by reference in their entirety to the same extent as if each individual patent or publication was specifically and individually indicated to be incorporated by reference.

All of the compositions and methods of production and application thereof disclosed herein can be made and executed without undue experimentation in light of the present disclosure. While the compositions and methods of the presently disclosed inventive concept have been described in terms of particular embodiments, it will be apparent to those of skill in the art that variations may be applied to the compositions and/or methods and in the steps or in the sequence of steps of the method described herein without departing from the concept, spirit and scope of the inventive concepts. All such similar substitutes and modifications apparent to those of skilled in the art are deemed to be within the spirit, scope and concept of the inventive concepts as defined herein.

As utilized in accordance with the methods and compositions of the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or when the alternatives are mutually exclusive, although the disclosure supports a definition that refers to only alternatives and “and/or.” The use of the term “at least one” will be understood to include one as well as any quantity more than one, including but not limited to 2, 3, 4, 5, 6, 7, 8, 9, 10, 15, 20, 30, 40, 50, 100, or any integer inclusive therein. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

Throughout this application, the term “about” is used to indicate that a value includes the inherent variation of error for the composition, the method used to administer the composition, or the variation that exists among the study subjects. Further, in this detailed description and the appended claims, each numerical value (e.g., temperature or time) should be read once as modified by the term “about” (unless already expressly so modified), and then read again as not so modified unless otherwise indicated in context. Also, any range listed or described herein is intended to include, implicitly or explicitly, any number within the range, particularly all integers, including the end points, and is to be considered as having been so stated. For example, “a range from 1 to 10” is to be read as indicating each possible number, particularly integers, along the continuum between about 1 and about 10. Thus, even if specific data points within the range, or even no data points within the range, are explicitly identified or specifically referred to, it is to be understood that any data points within the range are to be considered to have been specified, and that the inventors possessed knowledge of the entire range and the points within the range.

As used herein, the term “substantially” means that the subsequently described event or circumstance completely occurs or that the subsequently described event or circumstance occurs to a great extent or degree. For example, the term “substantially” means that the subsequently described event or circumstance occurs at least 90% of the time, or at least 95% of the time, or at least 98% of the time.

FIG. 1 is a perspective view of one possible writing instrument organizer configuration with markers in place. The organizer 10 comprises a front plate 12, back plate 14, and end caps 16. Front plate 12 contains at least one lid retention hole 18 which is sized so that it retains a standard marker lid 42 when the writing instrument body 40 is withdrawn from organizer 10. The organizer 10 shown in this embodiment can retain 4 standard writing instruments 40, such as markers or pens, and their lids 42.

FIG. 2 is a perspective view of an empty organizer 10. In this embodiment, front plate 12 has 4 lid retention holes 18 to allow 4 standard markers or pens to be stored within. Front plate 12 is held parallel at a distance from back plate 14 by end plates 16. This embodiment shows the end caps 16 attaching to front plate 12 by plate locking tabs 22 and end cap slots 24. This press-fit configuration allows a user to remove end caps 16 so that front plate 12 can be moved a sufficient distance from back plate 14 so a standard marker or pen lid may be inserted into the organizer.

FIG. 3 shows an exploded view of the writing instrument organizer. Front plate 12 has a plurality of lid retention holes 18 in it which are sized so that writing instrument lids cannot slip through. The ends of front plate 12 have plate locking tabs 22 which allow front plate 12 to be press fit into end tab slots 24 of each end plate 16. The back plate 14 has similar plate locking tabs 22 which press fit into a second set of end tab slots 24 in end plate 16. The sizes of the tabs and slots are sufficient to allow a press fit joint.

FIG. 4 is an alternative embodiment that shows some additional features. End cap 16 has been modified to include a mounting wedge 30 extending from its side. Mounting wedges 30 allows the entire assembly to be wedged between a wall and standard whiteboard. The size of mounting wedge 30 is sufficient to provide a snug fit so the assembly stays in place next to the whiteboard. Also shown are alignment holes 20 in back plate 14 which are arranged coaxially with the lid retention holes 18 in front plate 12. This arrangement keeps the markers or pens perpendicular to front plate 12 for a cleaner look.

FIG. 5 is an alternative embodiment of front plate 12 showing U retention slots 32 which extend from the edge of front plate 12 into lid retention holes 18. U retention slots 32 allow writing instruments with affixed lids to be inserted into the organizer by inserting the tip of the lid into lid alignment hole 20 then rocking the lid and instrument perpendicular to front plate 12 through U retention slots 32 into lid retention hole 18.

1. A writing instrument organizer comprising:
a front member having a plurality of perforations, the perforations having a shape and size appropriate to allow a tapered portion of a standard tapered lid of a writing instrument to pass partially through the perforation;
a back member disposed in a substantially parallel orientation relative to the front member; and
a spacing device for positioning said front and back members a predetermined distance apart, the predetermined distance less than a height of the standard tapered lid of the writing instrument such that the standard tapered lid of said writing instrument is removably retained between the front member and the back member.

2. (canceled)

3. (canceled)

4. The writing instrument organizer of claim 1, wherein the spacing device is removably attached to the front and back members.

5. The writing instrument organizer of claim 1, wherein the back member is provided with second perforations coaxial to the perforations of the front plate, the second perforations of a shape and size sufficient to prevent the writing instrument lid from passing through, the second perforations maintaining a longitudinal axis of the lid of the writing instrument perpendicular to the front member and the back member.
